(19) United States
(12) Patent Application Publication
(10) Pub. No.: US 2010/0019551 A1
(43) Pub. Date: Jan. 28, 2010

(54) SEAT FRAME HAVING AN IMPROVED STRUCTURE

(76) Inventor: Fabian Hernando Oviedo, Bogota (CO)

Correspondence Address: ABELMAN, FRAYNE & SCHWAB, 666 THIRD AVENUE, 10TH FLOOR, NEW YORK, NY, 10017, US

(21) Appl. No.: 11/917,901

(22) PCT Filed: Jun. 17, 2007
(86) PCT No.: PCT/IB05/01700

§ 371 Date: Jul. 2, 2009

(51) Int. Cl. B60N 2/68; B60N 2/24; A47C 5/12; B60N 2/44

(52) U.S. Cl. 297/183.6

(57) ABSTRACT

A frame for a seat or chair for use in vehicles for public transportation includes a back of the chair and a base zone. The frame includes a non-skid designed zone, a perforation in the base of the frame, and a rabbet that runs along the back of an upper portion of the frame. The upper portion forms a part of a principal handle, and two longitudinal rabbets are vertically displaced in the lateral parts of the flanks of the frame, which form part of laterally fastened handles. Two embedded joining supports are inside the frame.

### CROSS-REFERENCE TO RELATED APPLICATIONS

This application is a 371 of international application number PCT/IB2005/001700, filed on Jun. 17, 2005.

### BACKGROUND OF THE INVENTION

1. Field of the Invention

This invention is directed in a general way to the field of the frames of chairs which presents improvements that improve technical features of such frames, and in addition they can present an improved structure. In particular, this invention is directed to frames for chairs of vehicles used for public transportation.

2. Description of the Related Art

The first means of transport of passengers were made from a frame for chairs made of rigid materials like wood. These materials were replaced gradually with materials which were more flexible like leather that made travel more comfortable for the passenger. With the appearance of flexible foam, a technological change began, in which commodity and ergonomic considerations were the principal objectives. From this instant, new frames were developed with metallic structures and fiberglass structures that supported the foam.

Regrettably this kind of structure is usually attacked by acts of vandalism, such as scratching with pens or cutting the foam with sharp objects, that deteriorates the quality of the chair and makes the inside of the vehicle look bad.

In countries like Spain or Germany they copy the traditional concepts of frames for foam chairs by applying the procedures for transformation of thermoplastics obtaining the traditional square form for vehicle chairs. The industries that in the 1990s had a great development with this chairs are called Grammer Industrie GmbH with the model “Compacto”, Sistema Integral de Asientos Esteban with the model “Urban 90” and Vogel Industrie GmbH with the model “Pino”. By producing seats with this technique, a variation in the angle of the back of the chair is produced in a cooling manufacturing cycle because of the process of dimensional contraction which causes the movement in the seats. At the moment in which the frame must be installed, the back of the chair does not fit exactly in the structure making it necessary that arrangements for it to fit must be performed manually. This procedure makes the installation longer and more expensive.

Besides cleaning, which is a matter of great importance, easily improves the appearance and the hygiene of the vehicle. The vehicles are cleaned with water and detergent, leaving residues in the chair, thus deteriorating it. In addition, these chairs are designed for people of medium and large height, which makes a kid or a small person feel insecure inside the vehicle. This is due to the fact that there is typically only one vertical tube and no other way to protect the person. In the case in which the vehicle has to make an emergency stop, this people are the ones that suffer the most because of the insecurity of the mechanism.

Finally during the process of fabrication of the frames, more precisely, during the fabrication of the polymeric material, the angles between the base and the back of the chair usually do not fit. This generates more costs during installation.

In reference to FIG. 1, it can be appreciated that a conventional metallic support of the prior art that works as a union between the frame for the chair and the structure. This has four perforations in which the screws work as a union between the support and the frame to fix one in another. During the assembly of the support in the frame according to the method of the prior art, the support is fixed to the frame, which had no rigid elements, by joining screws but with the problem that the frame may move because of the lack of a rigid element. This happens during the time of assembly or at the moment of fabrication, and after the process of injection of the polymeric material during the process of assembly of the frame. As a consequence of the above, the original angles of the frames vary in the prior art at the moment of assembly between a base and a back of the chair. This created problems of delays in the prior art at the moment that the frames were going to be inserted in the metal support in a stage of assembly of the chairs in a vehicle because the accommodation of the angles had to be performed manually. These delays generated extra costs.

Now in reference to FIGS. 2-3, the lateral and frontal views of the support of the prior art shown in FIG. 1 can be seen.

From FIG. 4 it can be seen an isometric view of the mold in which the first embodiment of the frame is made. In FIG. 4, a mark of the body of the mold 8 and fixing inserts 9, such as hexagonal nuts, were previously lodged in the mold to then proceed to the injection of the polymeric material.

In reference to the FIG. 5, an amplified view of FIG. 4 is seen, in which one can observe with more detail, in an enlarged view, the metallic inserts 9 such as hexagonal nuts. These nuts are set in place manually using a metallic pin which is part of the mold.

In relation to FIG. 6, one can see a lateral view of the two frames where the difference of the angle is compared between the back and the base of the chair originated in the cooling or hardening phase of the polymeric material. This effect happens in the frame for chairs of the prior art and in the embodiments which do not have inserted therein the metallic support that brings additional rigidness to the frames. Therefore, the frames for chairs that have the metallic support fixed in the frame have a technological advantage.

In reference to FIG. 7, one can observe the way in which the conventional metallic supports 6, 7 must be fixed to the frame for the chair according to the prior art.

### SUMMARY OF THE INVENTION

The invention is directed to the improvement of frames of a chair which improves a technical aspect, and in addition it may present an improved structure that will solve the problems of prior art techniques. This frame can be made of thermoplastic material or special alloy material, such as fiberglass, resin, etc., and by traditional processes of transformation. This frame is durable because of the toughness of the material and the resistance to ripping, so it makes the frame suitable against acts of vandalism. In addition, these materials are easy to clean in contrast with prior art chairs made of foam. This frame for chairs has a system of drains that stops the discoloration and the loss of mechanical resistance. Children and small persons are guaranteed safety by having two lateral handles.

With its ergonomic design and a non-skid device, the frame guarantees adherence of the person to the chair. The frame of the chair has a perforation on the right or on the left side of the back, which works for the protection of children and small persons. Optionally, the metal structures may be inserted into the frame of the chair before the injection process to reduce the variations of the angle between the base and the back of the chair which was generated on the moment of assembly. Now the structure works as a framework which stops the movement of the frame in the moment of assembly. In this way the indirect costs of installing the frame of the chair inside the vehicle are decreased. In addition, the frame of the chair may have an additional hole in the side of the back of the chair that may be employed as an additional security to provide a belt or a harness.

In the upper part of the back of the chair there is a hole that acts as a principal handle. In the middle of the base of the chair there is a hole that works as a drain or as an anchorage in the case in which there are safety belts. This drain makes the water flow efficiently, avoiding the residues of water of detergent that attack the material and deteriorate the appearance of the frame on the inside and outside. Nowadays, the frames which do not present this drain suffer from age that creates discoloration on parts of the chair. The back of the frame of the chair may present a non-skid device to mitigate forces of the vehicle such as an unexpected break.

### BRIEF DESCRIPTION OF THE SEVERAL VIEWS OF THE DRAWINGS

FIG. 1 is an isometric view of a conventional support of the prior art.

FIGS. 2-3 are lateral and frontal views of the conventional support of the prior art.

FIG. 4 is an isometric view of a cavity of a mold of the prior art.

FIG. 5 is an enlarged view of the mold of FIG. 4 of the prior art.

FIG. 6 is a lateral view of two frames of the prior art together in which the difference in the angle in the hardening is visible.

FIG. 7 is a back view of the ensemble of the conventional supports with the frames of the chair in the prior art.

FIG. 8 is an exploded view of the ensemble of the two frames for the chairs in FIG. 7 including the respective conventional supports and a fixation structure according to the prior art.

FIG. 9 is the new develop support of the invention.

FIG. 10 is the lateral view of the previous support.

FIG. 11 is an isometric view of the position of the new support inside the mold.

FIG. 12 is an enlarged view of FIG. 11.

FIG. 13 is a rear view of the frame of the chair of the present invention with newly developed supports.

FIG. 14 is an exploded view of the ensemble of the frame of FIG. 13 with the supports on the inside.

FIG. 15 corresponds to a resistance analysis made to the conventional support of the prior art.

FIG. 16 is an enlarged partial view of FIG. 15.

FIG. 17 is a comparative view of the movement caused to the conventional support when a force of 875 Newtons is applied according to the prior art.

FIG. 18 corresponds to a resistance analysis made to the new support developed in the present invention.

FIG. 19 is an enlarged partial view of FIG. 18.

FIG. 20 is a comparative view of the movement caused to the new support of the present invention when a force of 875 Newtons is applied.

FIG. 21 is an isometric view of a first embodiment of the frame for chairs.

FIG. 22 is a frontal view of the FIG. 23.

FIG. 23 correspond to the back view of a first embodiment of the present invention.

FIG. 24 is a lateral view of the present invention in FIG. 23.

FIG. 25 is a frontal view of a second embodiment of the present invention of the frame for chairs.

FIG. 26 is a lateral view of the present invention in FIG. 25.

FIG. 27 is an isometric view of the second embodiment of the present invention.

FIG. 28 is a lateral view of the third embodiment of the present invention.

FIG. 29 is a lateral view of the present invention in FIG. 28.

FIG. 30 is a top plan view of the third embodiment of the present invention.

FIG. 31 is an isometric view of the present invention in FIG. 30.

FIG. 32 is a frontal view of a fourth embodiment of the present invention.

FIG. 33 is a lateral view of the present invention in FIG. 32.

FIG. 34 is a top plan view of the fourth embodiment of the present invention.

FIG. 35 is an isometric view of the present invention in FIG. 34.

FIG. 36 is a top plan view of the fourth embodiment of the present invention of the frame for chair.

### DETAILED DESCRIPTION OF THE INVENTION

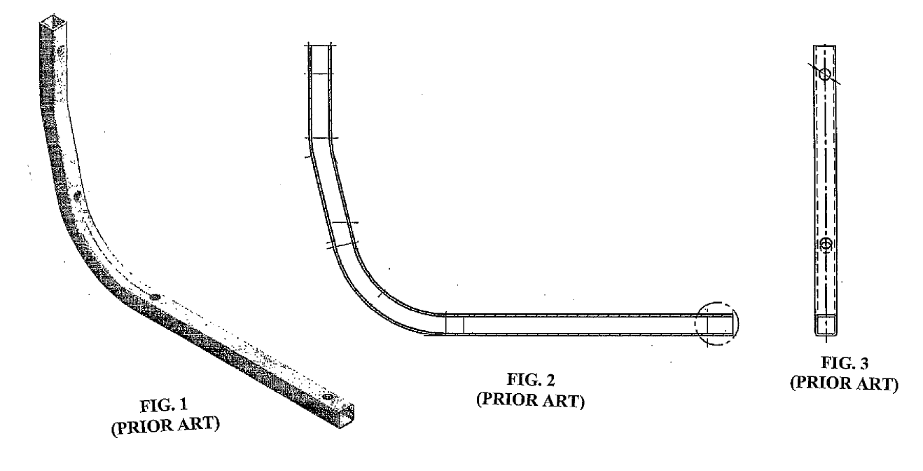

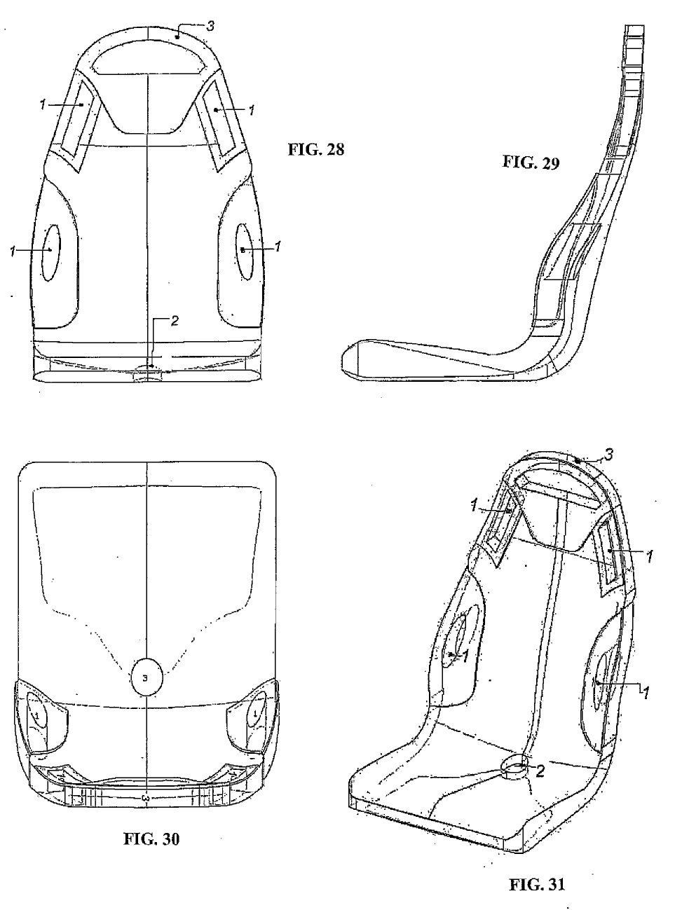

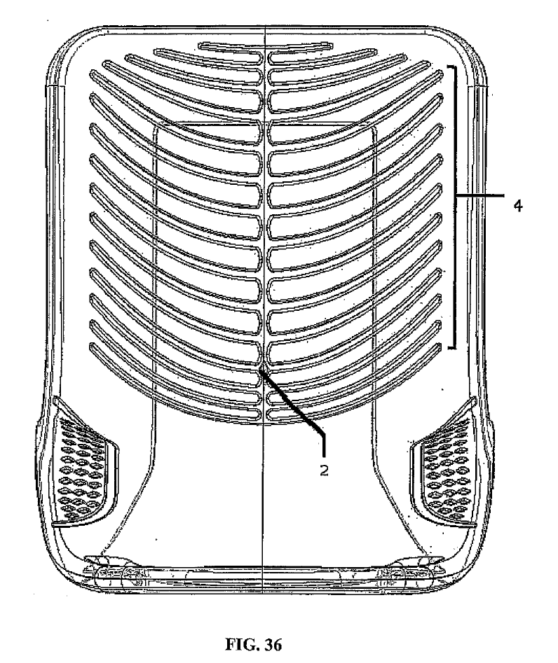

The present invention is shown in FIGS. 8-36. In FIG. 8, an exploded view of the frames 1 for chair of the first embodiment of the present invention is shown, joined to a conventional support 2-5, as shown in FIG. 1 and the structure of the support 6. This frame 1 of the present invention has a back and a base of the chair and it is made of a polymeric material that can be any material made for this purpose, but is preferred to be polyethene of high density. This frame 1 of the present invention for a chair has a non-skid design, which in this case is a corrugate that cannot be seen in FIG. 8. In addition, the frame 1 has a perforation or a hole that avoids liquid substances accumulating in the base of the frame 1 of the chair. The perforation is a hole that runs through the highest part of the back of the chair that is a part of a principal handle. and two longitudinal scratches that move vertically on the lateral parts of the sides of the chair that forms part of the lateral handles. The hardness of the material makes acts of vandalism difficult to be perform, and also makes the cleaning of the chair easier when it has been stained. On the other hand, the hole prevents the accumulation of substances such as water or detergent or other liquid substances that may fall accidentally and accumulate on the base of the chair.

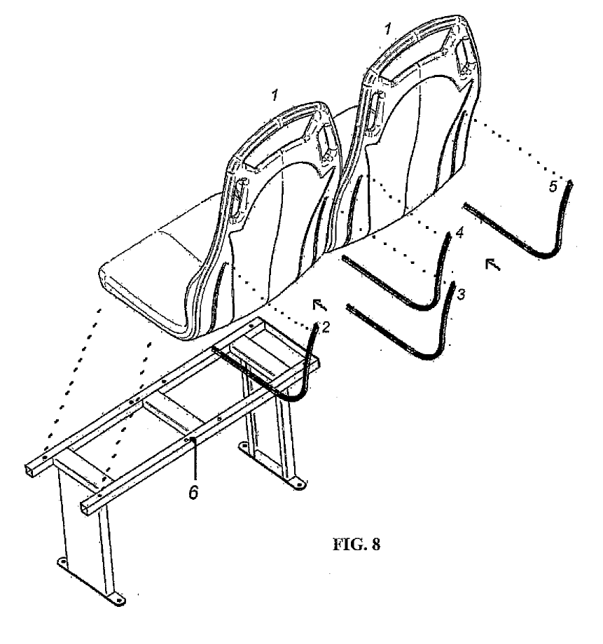

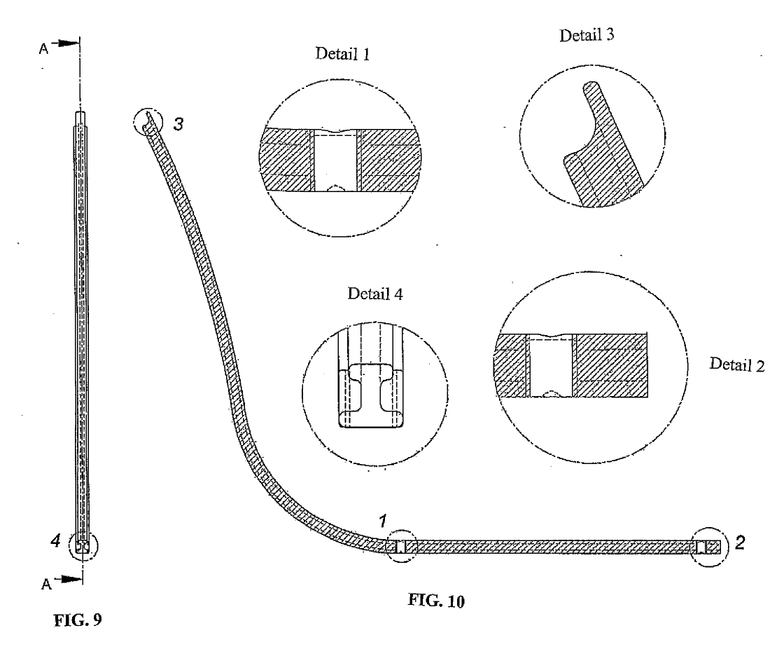

In relation to FIG. 9, one can see a frontal view of the new union support that employs the three other embodiments of the invention described herein. The elements 1-2 correspond to twisted holes where the joining screws should pass that should fix the frame for the chair and the base structure that should be fixed to the vehicle. In addition, element 3 corresponds to a fixing extending member which has, as an objective, a better adherence of the support that works as a skeleton of the frame for the chair with the polymeric substance that is injected to fabricate the frame for the chair. Finally element 4 corresponds to a transversal section of the metallic support that, as can be seen, has an “I” profile or a rail-type configuration with the objective of accomplishing the necessary adherence between the support and the polymeric material that conforms to the frame. The support stays totally inside the chair frame, giving the support the necessary rigidness which stops the variation of the angle between the back and the base of the frame for the chair, but which variation is given in the mold to the frame of the chair according to the prior art and that does not happen in the embodiment that does not receive it.

According to FIG. 10, one can see a lateral view of the support of the frame in FIG. 9. In this figure elements 1-2 show a screw hole in which passes a joining screw between the frame and the structure. It is important to know that this support is fabricated in any material that has the technical requirements necessary for application as polymeric material, wood or metal, with the best material being metal.

As shown in FIG. 11, an isometric view of the mold is illustrated, with the mold being used in connection with the fourth embodiment of the present invention. In FIG. 11, element 8 shows the body of the mold, and element 10 is the metallic support of FIG. 9 located inside the mold which will be part of the frame.

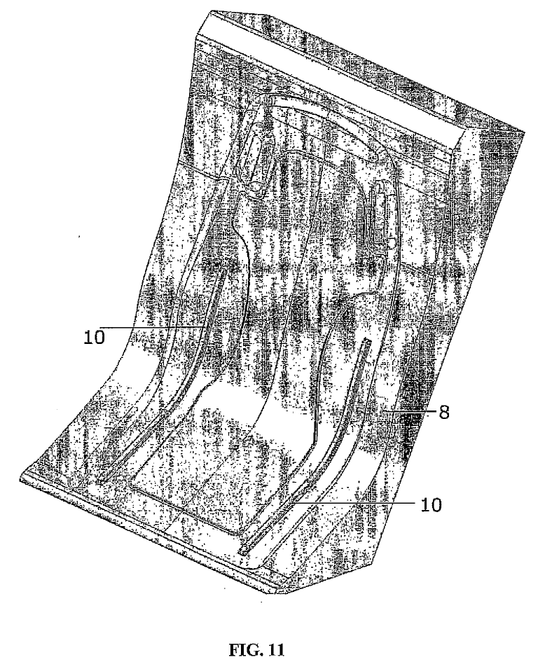

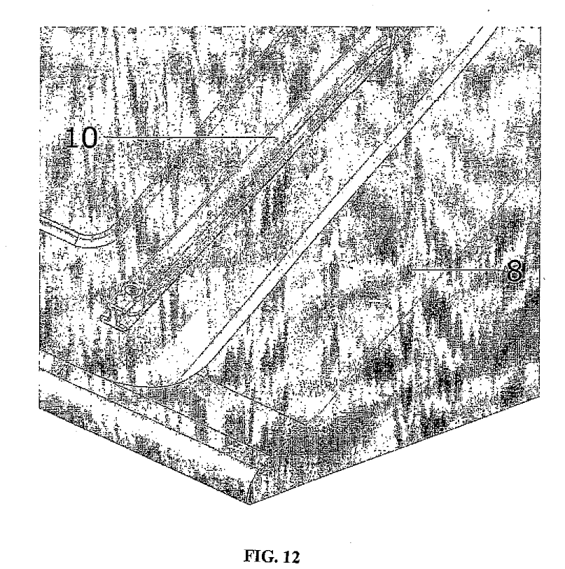

FIG. 12 is an enlarged view of FIG. 11. In FIG. 12, one can see element 10 which is an initial extreme end of the metallic support and with the body 8 of the mold.

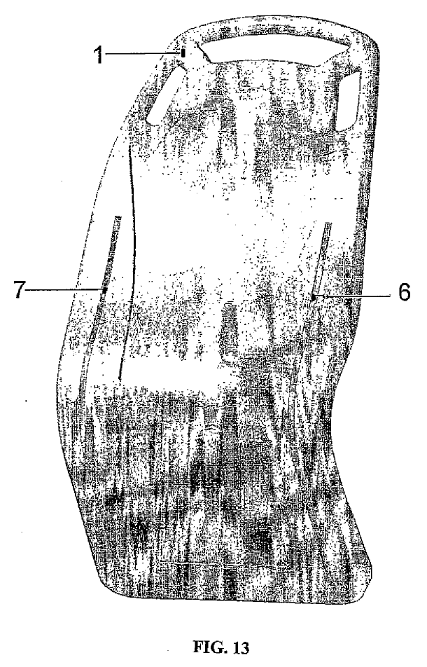

FIG. 13 is a rear view of the mold of FIG. 11, in which the joining supports 6-7 are absorbed inside the frame for chair and where one can see the face of the “1” structure or rail-type structure. This kind of absorbed support is use for the second, third, and fourth embodiments of the present invention.

FIG. 14 is an exploded view of the assembly 1 shown in the second, third and fourth embodiments, in which are included the metal supports of FIG. 9. Also the structure 6 is shown with each of the parts involved and the possibility of direct assembly of the frame to the support of the structure which is fix to the vehicle, saving materials and time in the process when uniting the frame of the chair to the vehicle.

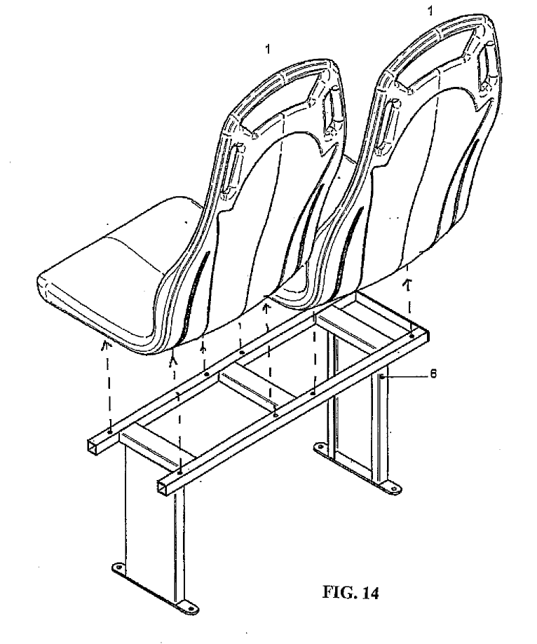

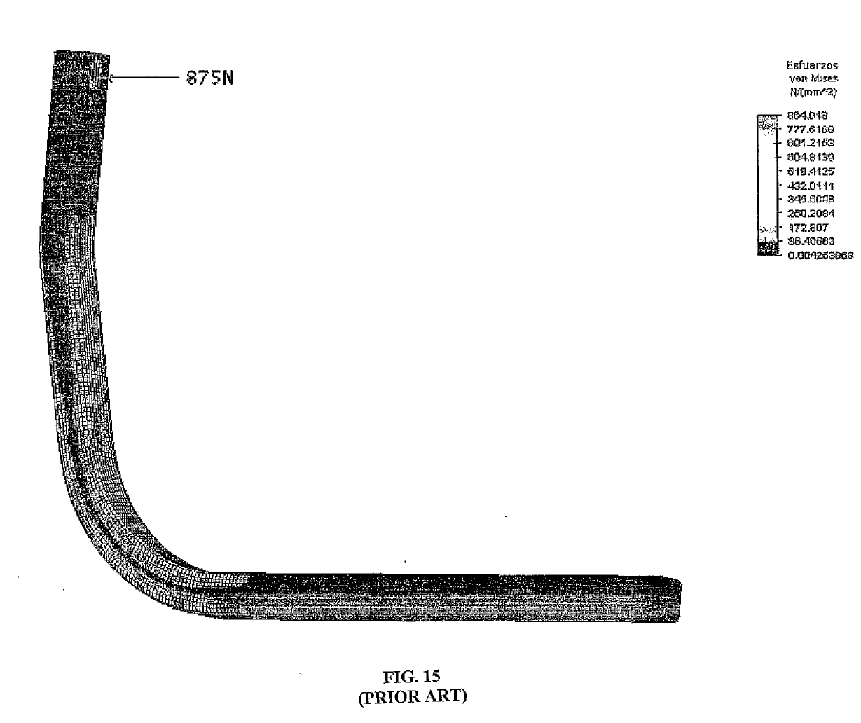

FIG. 15 is the computer aided engineering (CAE) analysis of forces and displacements simulated by a computer of the conventional metal support of FIG. 1 in the prior art. A force of 875 Newtons has been applied to this support. FIG. 15 shows that the major concentration of forces is located in the elbow of the part, which is a zone where it can fail.

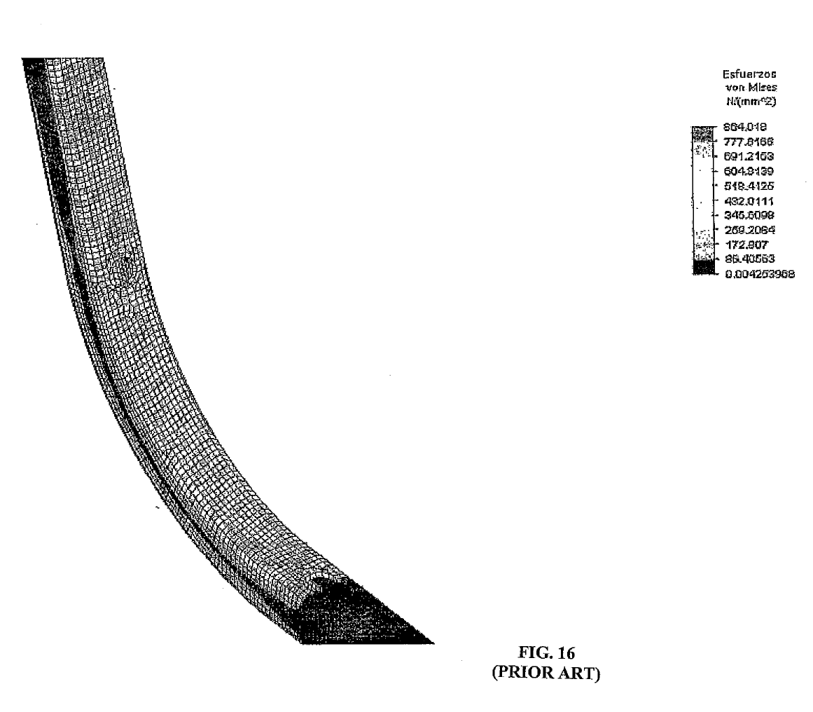

FIG. 16 is a large view of FIG. 15, with the result of the analysis of the forces made to the aforementioned support in FIG. 15. In FIG. 16, one can see a closer view of the zone where failure may occur.

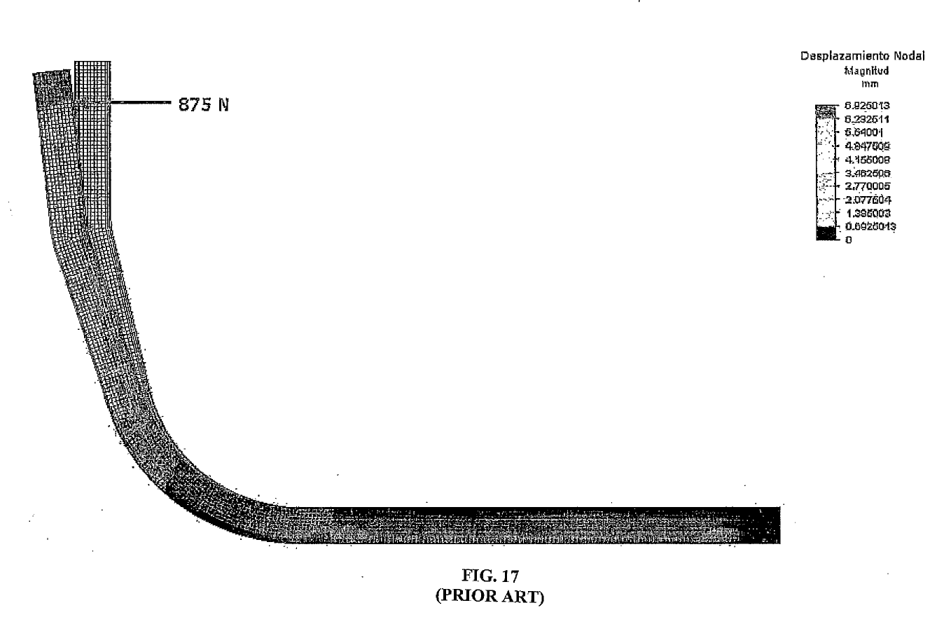

FIG. 17 is a lateral view of the result of the analysis on the displacement of the conventional support. The frame without the coloring variation that can be seen in FIG. 17 is the original position of the support without the application of force in which one can see the levels of the movement.

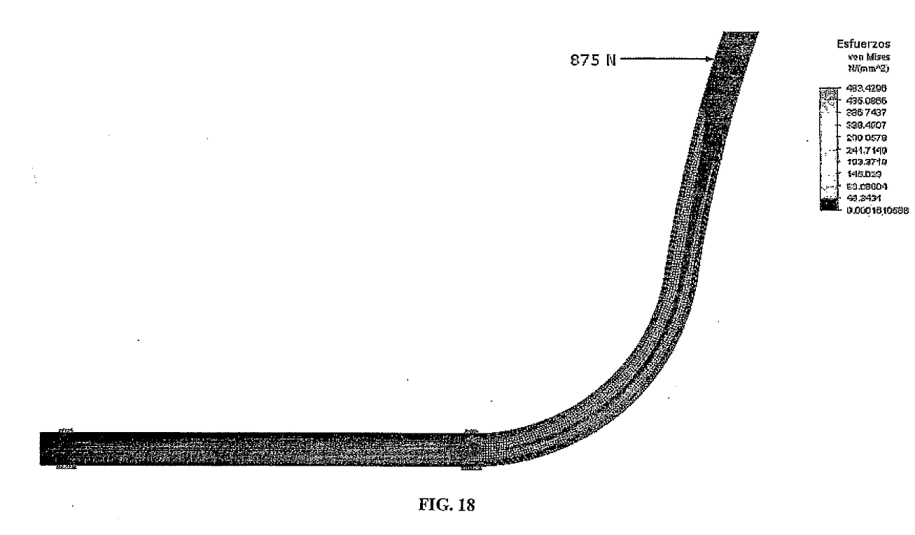

FIG. 18 is a lateral view of the force analysis of the new support assembly of FIG. 9. For this analysis, a force of 875 Newtons has been applied.

FIG. 19 is an enlarged view of the analysis of forces of the new support. In this region the greatest number of forces is concentrated.

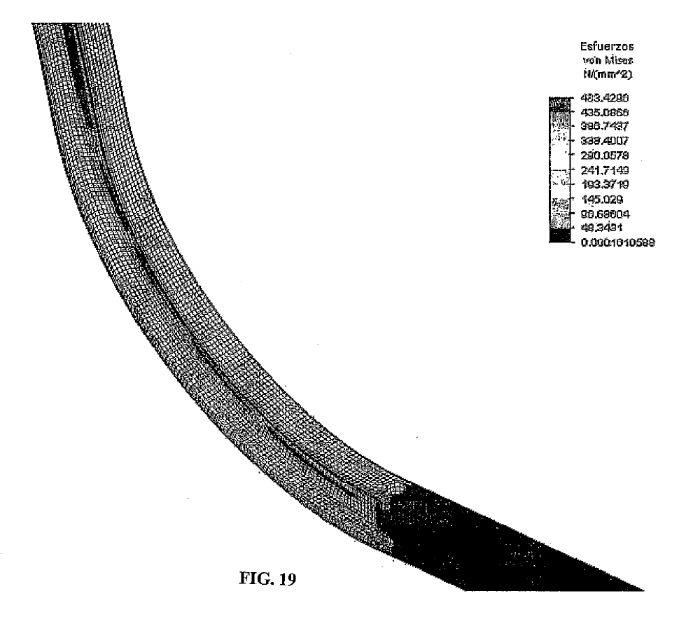

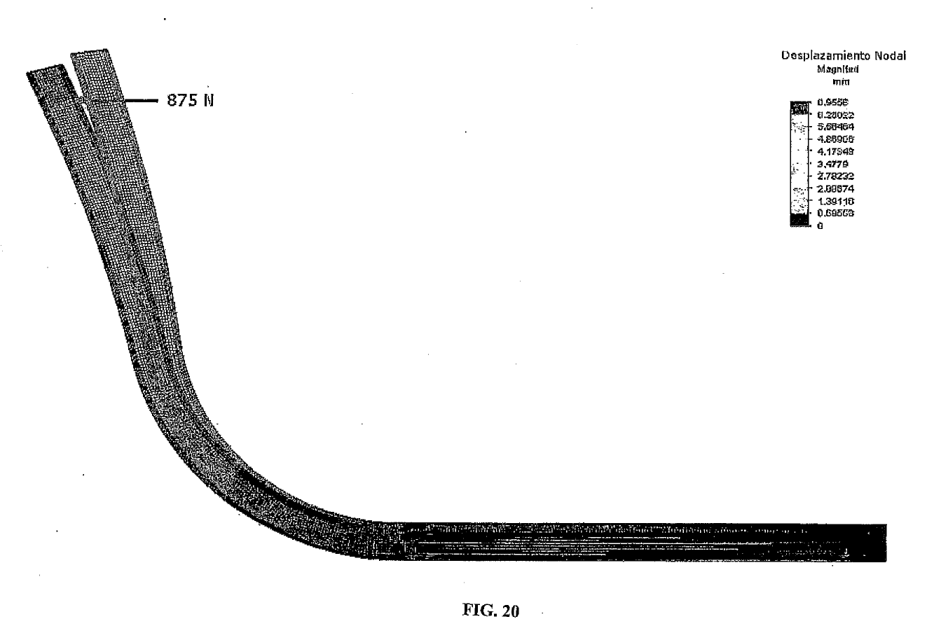

FIG. 20 is a lateral view of the result of the analysis in the displacement of the new support. The frame without the coloring variation that can be seen in FIG. 20 is the original position of the support without application of any force, by which one can see the levels of displacements.

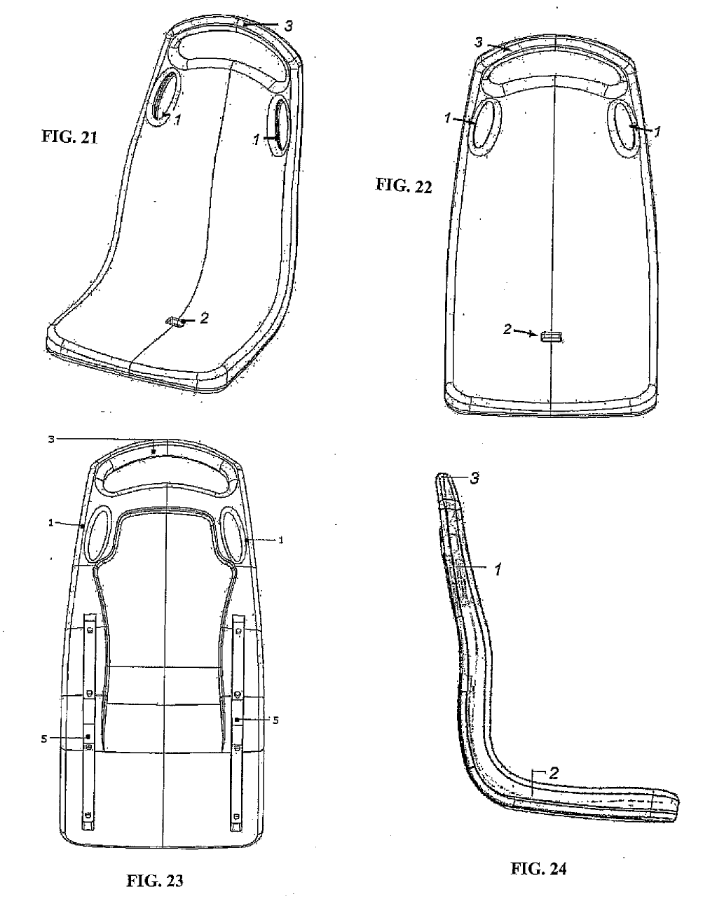

In FIG. 21, the first embodiment of chair frame is shown in greater detail, in which this chair frame is made of a polymeric material that may be any material made for this purpose, but it is better to use polyethylene of high density. The frame of the chair has a non-skid design, in this case a corrugated design that cannot be seen in the image. In addition the frame has a hole or perforation that avoids the accumulation of any liquid substance on the base of the chair. The frame also has groove that runs through the upper part of the back of the frame that is part of the principal handle. The frame also has two longitudinal grooves that run vertically through the lateral part of the sides that are part of the lateral handles. The hardness of the material prevents acts of vandalism, and also makes cleaning easier when it has been stained. On the other hand, the hole prevents the accumulation of substances like water or detergent or other liquid substances that may fall accidentally and accumulate on the base of the chair. Elements 1 are the lateral fastened handles, element 2 is a drain hole, and element 3 is the principal fastened handle.

On the other hand, FIGS. 22-24 show the front, rear, and lateral views of the first embodiment of the frame for the chair of the present invention. This is the only embodiment of the invention that employs the conventional metallic support that is shown in the FIG. 1.

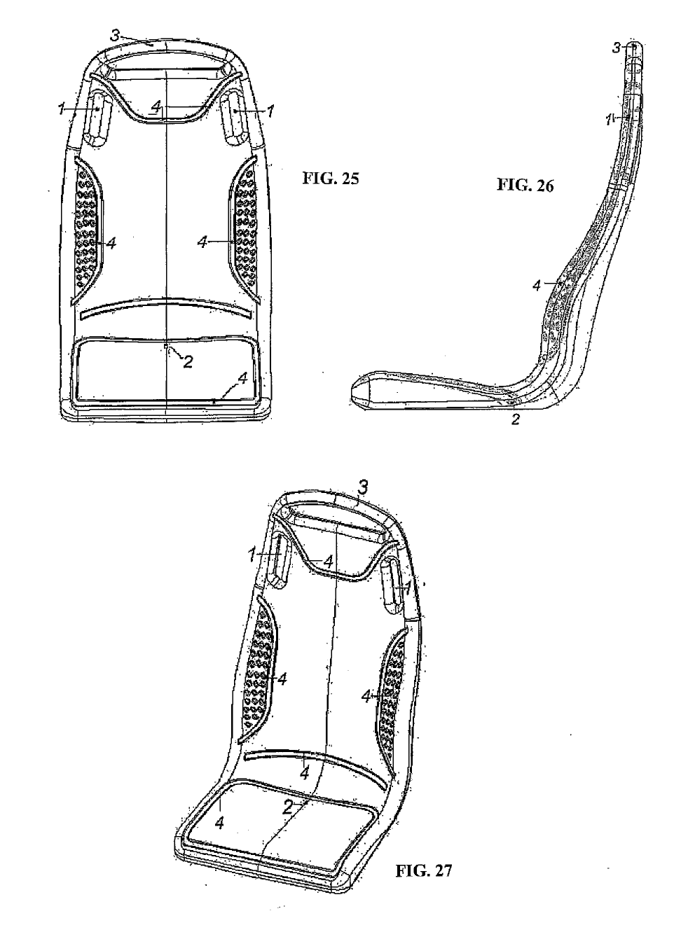

FIG. 25 is a frontal view of the second embodiment of the frame of the chair. A non-skid zone 4 is shown which is located on the lateral left side and lateral right side of the back of the frame as shown in FIG. 25. This zone 4 is formed by geometric variation in relief that helps the assembler of the frame add components to the frame and stops its movement. These non-skid zones give more resistance to the back of the chair. However this embodiment does not have a non-skid surface on the base of the chair. In addition it has a hole or perforation that prevents any liquid substance from accumulating on the base of the chair. It has a groove that runs through the upper part of the back of the chair which has the principal fastened handle 3 over it. The second embodiment has two longitudinal grooves that conforms the lateral right and left fastened handles 1 that run through the lateral parts of the sides of the back of the frame of the chair.

FIGS. 26-27 correspond to lateral and isometric views of the second embodiment previously shown. This second embodiment has the new joining support shown FIGS. 9-10 which is embedded in the polymeric material.

FIG. 28 is the third embodiment of a frame for chairs. In FIG. 28, elements 1 are the lateral fastened handles, and in the low side of the back of the frame, additional left and right side handles are provided that have the double function to operate as seat belts. Element 2 is a drain hole and element 3 is the principal fastened handle. Unlike the previous embodiments of the present invention, the third embodiment does not include a non-skid zone, but it has the option to include a seat belt or a harness.

FIGS. 29-31 show the lateral, top, and isometric view of this third embodiment, which possesses the new joining support illustrated in FIGS. 9-10 which, as previously described, are embedded in the polymeric material from which the chair frame is formed.

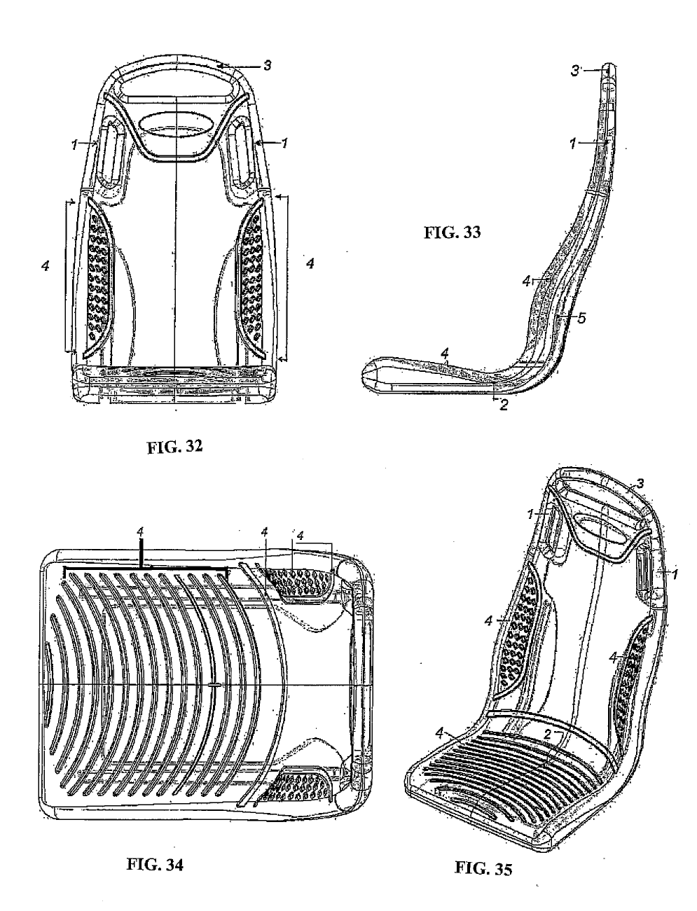

FIG. 32 illustrates a fourth embodiment of a chair frame, in which the non-skid zone 4, the upper handle 3, and the lateral handles 1 can be seen. As shown in FIG. 32 and its related FIGS. 33-35 which correspond the lateral, superior and isometric views, the non-skid zone 4 can be found in both right and left sides of the back of the chair in a similar way as described in connection with the second embodiment and, additionally, this non-skid zone 4 is extended in the whole base of the chair frame to provide better mechanical resistance to the back and to the base of the chair frame. This fourth embodiment, as all the previous embodiments, includes a hole that prevents liquid accumulation, a rabbet or recess or groove that goes along of the back of the upper part of the chair frame which is located under the main fastened handle 3, and two longitudinal rabbets which conform the lateral fastened handles on the right and left that are located vertically in the lateral parts of the back of the flanks of the chair. This fourth embodiment possesses the new joining support illustrated in FIGS. 9-10 which, as previously described, are embedded in the polymeric material from which the chair frame is formed.

FIG. 36 is a top plan view of the fourth embodiment with a possible variation in the base of the chair frame, in which can be seen a “fish skeleton” or “fish bone” design. A drainage hole is located above a central line or skeletal axis, with the purpose of easing the flow of water or the dislodging of detergents that might be used, and so to avoid their accumulation.

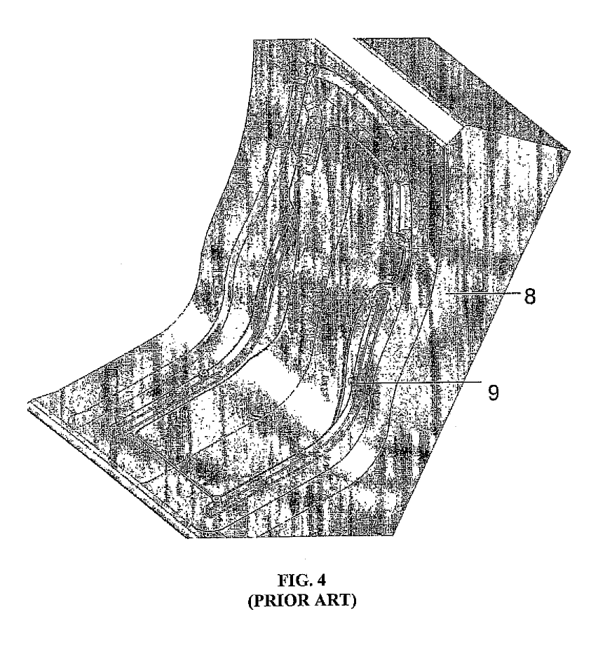

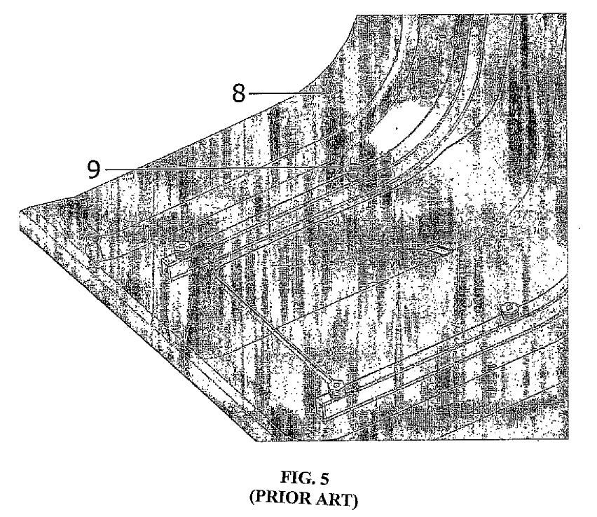

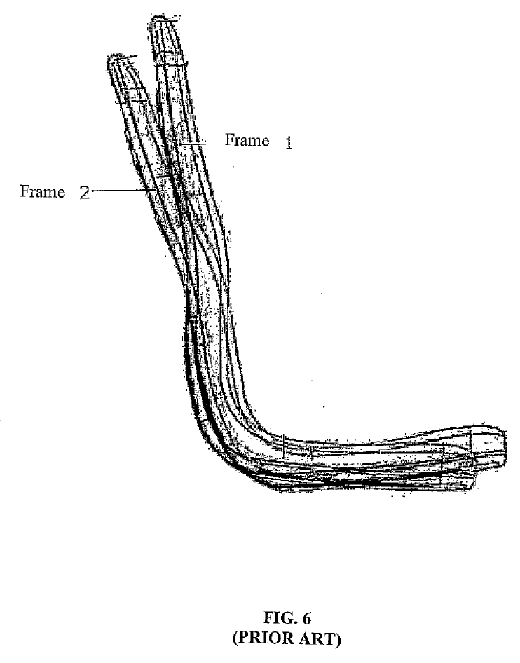

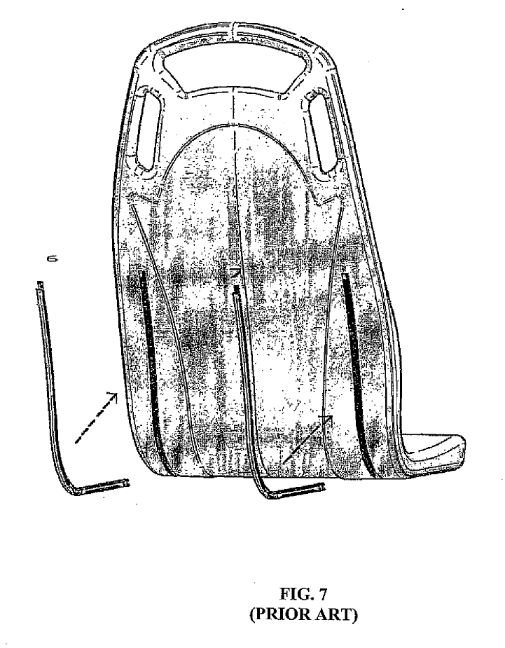

Regarding the fabrication of the chair frames of the present invention, the process of extrusion molding in the prior art can be used. In a detailed manner, the fabrication process includes the fixation of these frames, by the extrusion molding process, to the respective structure, where is necessary to use eight female screw holes and two metallic conventional supports, as shown in FIGS. 1-5. These female screw holes are located inside the mold as metallic inserts that adhere to the plastic after performing the molding procedure. At the end of this process the chair frame is taken out from the mold, and a cooling stage begins, where the cooling frame contracts by four percent. When the frame contracts, an angular variation of the back of the chairs frame can appear that can be noticeably seen while two pieces are positioned laterally.

In order to reduce the costs and fabrication time of the chair frame by the extrusion-molding method of the prior art, a metallic support as shown in FIG. 9 will be employed. This support includes two screw holes that work as a female screw hole, eliminating in this manner the necessity of using different screws. These supports are located inside the mold as a metallic insert, as in FIGS. 11-12, that adhere themselves to the plastic after formation in the molding process. The support has a special “I” section, as shown by section 4 in FIG. 10, that permits the internal walls of the chair frame to adhere themselves completely to the support. The metallic support also helps to maintain the inclination angle of the back of the chair because this element gives rigidness and produces a restriction in movement.

When comparing the fabrication method in which are employed the screw-fastening system and conventional support in an independent manner against the fabrication with support method that includes screws, the manufacturer can attain a 34% saving in the costs of fabrication, as shown in Table 1 describing a screw-fastening fabrication method versus a support fabrication with screws included.

TABLE 1

| | | | |
|---|---|---|---|
| | COST | QUANTITY/ | COST |
| DESCRIPTION | UNIT | FRAME | SUBTOTAL |

FASTENING WITH SCREWS AND
CONVENTIONAL SUPPORT SYSTEM

| | | | |
|---|---|---|---|
| Fastening screw | $225 | 8 | $1.800 |
| M8 × 1.25 × 10 | | | |
| Conventional metallic | $2.950 | 2 | $5.900 |
| support | | | |

| | |
|---|---|
| FASTENING SYSTEM TOTAL COST | $7.700 |

FASTENING WITH SUPPORT THAT INCLUDES A SYSTEM
OF SCREW HOLES THAT WORK AS FEMALE SCREW SYSTEM

| | | | |
|---|---|---|---|
| Metallic screwed | $2200 | 2 | $4.400 |
| support | | | |

| | |
|---|---|
| NEW FASTENING SYSTEM COST TOTAL | $4.400 |

In order to establish this system, a comparative analysis of forces and displacements of the conventional support in FIG. 1 against the new joining support of FIG. 9 has been made. This analysis was made with the aid of software using CAE. The data employed for the simulation analysis appears in Table 2, describing the parameters employed in the comparative simulation of the support efforts and displacements analysis.

TABLE 2

| DESCRIPTION | VALUE |
|---|---|
| Colombian technique norm | 4901 - 2 section 2.1.11 |
| Earth's Gravity Value, in mm/s² | 9814.56 |
| Applied Force Value, in Newtons | 875 |
| Type of analysis | Static |
| Support fabrication material | ASTM A36 |
| Joint components simulation | Soldering |

The obtained results at force levels for the comparative analysis of the supports appear in Table 3. It is observed that all efforts are reduced to half, in which the maximum effort is reduced from 864 N/mm² to 483 N/mm². One can conclude that the safety factor with the new support system is approximately doubled, in which it passes from 8.9 to 15.9, improving the useful life of the piece and augmenting the trustworthiness for the passenger if an accident or anything unforeseen appears, for the embodiments shown in FIGS. 15-20. Table 3 is a comparative table of forces held up by the two options of supports applying an 875 Newton force.

1-9. (canceled)

10. A frame for a seat for use in vehicles for public transportation, the frame comprising:
a back member forming a back of the seat and having an upper portion;
a base zone;
a non-skid designed zone for retaining a passenger sitting in the seat;
a perforation in the base of the frame for permitting the flow of liquid out from the seat;
a rabbet that runs along a back of the upper portion of the frame;
two longitudinal rabbets vertically displaced in lateral parts of the flanks of the frame, which form part of laterally fastened handles;
two embedded joining supports inside the frame for joining the frame to the vehicle; and
wherein the upper portion forms a part of a principal handle.

11. The frame of claim 10, wherein the frame is composed of a polymeric material.

12. The frame of claim 11, wherein the polymeric material includes high density polyethylene.

13. The frame of claim 10, wherein the non-skid zone is positioned only on a lateral flank of the back of the frame.

14. The frame of claim 11, wherein the non-skid zone is positioned only on a lateral flank of the back of the frame.

15. A frame for a seat for use in vehicles for public transportation, the frame comprising:
a back member forming a back of the seat and having an upper portion and a lower portion, wherein a lateral flank of the lower portion includes a hole therethrough for functioning as a fastened handle and for receiving a safety harness;
a base zone;
a perforation in the base of the frame for permitting the flow of liquid out from the seat;
a rabbet that runs along a back of the upper portion of the frame;
two longitudinal rabbets vertically displaced in lateral parts of the flanks of the frame, which form part of laterally fastened handles;
two embedded joining supports inside the frame for joining the frame to the vehicle; and
wherein the upper portion forms a part of a principal handle.

16. The frame of claim 15, wherein the frame is composed of a polymeric material.

17. The frame of claim 16, wherein the polymeric material includes high density polyethylene.

18. The frame of claim 10, wherein the non-skid zone is positioned in both a right flank and a left flank of the back of the chair, with the non-skid zone extending through the entire base zone.

19. The frame of claim 11, wherein the non-skid zone is positioned in both a right flank and a left flank of the back of the chair, with the non-skid zone extending through the entire base zone.

20. The frame of claim 10, wherein the assembled frame and chair are attached to an assembly support having an “L” rail-type profile, with the assembly support fixedly attached to the body of the vehicle;
wherein the assembly support includes screw holes for receiving joining screws which hold the frame to the assembly support; and
wherein the frame includes a fixing extending member.

21. A frame for a seat for use in vehicles for public transportation, the frame comprising:
a back member forming a back of the seat and having an upper portion;
a base zone;
a non-skid designed zone for retaining a passenger sitting in the seat;
a perforation in the base of the frame for permitting the flow of liquid out from the seat;
a rabbet that runs along a back of the upper portion of the frame which is a part of a main handle;
two longitudinal rabbets vertically displaced in lateral parts of the flanks of the frame, which form part of laterally fastened handles; and
two embedded joining supports inside the frame for joining the frame to the vehicle.

22. The frame of claim 21, wherein the frame is composed of a polymeric material.

23. The frame of claim 22, wherein the polymeric material includes high density polyethylene.

24. The frame of claim 21, wherein the non-skid zone has a corrugated form.

25. The frame of claim 22, wherein the non-skid zone has a corrugated form.
